(19) United States
(12) Patent Application Publication
(10) Pub. No.: US 2024/0237108 A1
(43) Pub. Date: Jul. 11, 2024

(54) IAB MULTI-PARENT UPLINK-DOWNLINK ALIGNMENT

(71) Applicant: Telefonaktiebolaget LM Ericsson (PUBL), Stockholm (SE)

(72) Inventors: Boris DORTSCHY, Vendelsö (SE); Lei BAO, Göteborg (SE); Magnus ÅSTRÖM, Lund (SE)

(21) Appl. No.: 18/559,888

(22) PCT Filed: May 10, 2022
(86) PCT No.: PCT/EP2022/062705

§ 371 Date: Nov. 9, 2023

Related U.S. Application Data
(60) Provisional application No. 63/186,230, filed on May 10, 2021.

(51) Int. Cl. H04W 76/15; H04W 72/02; H04W 72/563; H04W 88/08

(52) U.S. Cl. CPC H04W 76/15; H04W 72/02; H04W 72/563; H04W 88/08

(57) ABSTRACT

According to some embodiments, a method is performed by an integrated access and backhaul (IAB) node in dual connectivity where an IAB-MT is connected to two IAB parents and two IAB donors. The method comprises: obtaining (1212) a semi-static flexible resource configuration from an IAB donor; obtaining (1214) a first uplink/downlink resource indication for a semi-statically configured flexible resource from a first IAB parent and a second uplink/downlink resource indication from a second IAB parent; obtaining (1216) a priority associated with the first IAB parent and a priority associated with the second IAB parent; determining (1218) the first and second uplink/downlink resource indications conflict; selecting (1220) one of the first and second uplink/downlink resource indications based on the priority associated with the first and second IAB parents; and communicating (1222) with the two IAB parents according to the selected uplink/downlink resource indication.

### TECHNICAL FIELD

Particular embodiments relate to wireless communication, and more specifically to integrated access and backhaul (IAB) multi-parent uplink-downlink alignment.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Densification of wireless networks via the deployment of more and more base stations (macro and/or micro base stations) is one mechanism to satisfy the ever-increasing demand for more and more bandwidth/capacity in mobile networks. Due to the availability of more spectrum in the millimeter wave (mmw) band, deploying small cells that operate in this band is an attractive deployment option. Deploying fiber to the small cells, however, which is the usual way in which small cells are deployed, can be expensive and impractical. Thus, employing a wireless link for connecting the small cells to the operator's network is a cheaper and practical alternative. One such solution is an integrated access and backhaul (IAB) network, where the operator can use part of the radio resources for the backhaul link.

FIG. 1 illustrates an IAB deployment that supports multiple hops. The IAB donor has a wired connection to the core network and the IAB-nodes are wirelessly connected using fifth generation (5G) new radio (NR) to the IAB-donor, either directly or indirectly via another IAB-node. The connection between IAB-donor/node and a user equipment (UE) is referred to as the access link, and the connection between two IAB-nodes or between an IAB-donor and an IAB-node is referred to as the backhaul link.

Furthermore, as illustrated in FIG. 2, the adjacent upstream node that is closer to the IAB-donor of an IAB-node is referred to as a parent node of the IAB-node. The adjacent downstream node that is further away from the IAB-donor of an IAB node is referred to as a child node of the IAB-node. The backhaul link between the parent node and the IAB-node is referred to as parent (backhaul) link, and the backhaul link between the IAB-node and the child node is referred to as the child (backhaul) link.

One major difference of the IAB architecture compared to Rel-10 long term evolution (LTE) relay (besides lower layer differences) is that the IAB architecture adopts the Central-Unit/Distributed-Unit (DU/DU) split of gNBs in which time-critical functionalities are realized in IAB-DU closer to the radio, and the less time-critical functionalities are pooled in the CU with the opportunity for centralization. Based on this architecture, an IAB-donor contains both CU and DU functions.

In particular, the IAB-donor contains all CU functions of the IAB-nodes under the same IAB-donor. Each IAB-node then hosts the DU function(s) of a gNB. To transmit/receive wireless signals to/from the upstream IAB-node or IAB-donor, each IAB-node has a mobile termination (MT), a logical unit providing a necessary set of UE-like functions. Via the IAB-DU, the IAB-node establishes radio link control (RLC)-channel to UEs and/or to MTs of the connected IAB-node(s). Via the IAB-MT, the IAB-node establishes the backhaul radio interface towards the serving IAB-node or IAB-donor. FIG. 3 illustrates a reference diagram for a two-hop chain of IAB-nodes under an IAB-donor.

Wireless backhaul links are vulnerable to blockage, e.g., due to moving objects such as vehicles, due to seasonal changes (foliage), severe weather conditions (rain, snow, or hail), or due to infrastructure changes (new buildings). Such vulnerability also applies to IAB-nodes. Also, traffic variations can create uneven load distribution on wireless backhaul links leading to local link or node congestion. In view of those concerns, the IAB topology supports redundant paths as another difference compared to the Rel-10 LTE relay.

IAB topologies include spanning tree (ST) and directed acyclic graph (DAG), as illustrated in FIG. 4. The arrow indicates the directionality of the graph edge.

One IAB-node can have multiple child nodes and/or have multiple parent IAB-nodes. Particularly regarding multi-parent topology, different scenarios may be considered as illustrated in FIG. 5. For example, IAB-9 connects to IAB-donor 1 via two parent nodes IAB-5 and IAB-6 which connect to the same grandparent node IAB-1. IAB-10 connects to IAB-donor 1 via two parent nodes IAB-6 and IAB-7 which connect to different grandparent nodes IAB-1 and IAB-2. IAB-8 connects to two parent nodes IAB-3 and IAB-4 which connect to different IAB-donors IAB-donor 1 and IAB-donor 2.

The multi-connectivity or route redundancy may be used for back-up purposes. Also, redundant routes may be used concurrently, e.g., to achieve load balancing, reliability, etc.

According to IAB TR 38.874, when operating in SA-mode, an NR+NR dual connected IAB-node can add redundant routes by establishing an MCG-link (master cell group) to one parent node IAB-DU and an SCG-link (secondary cell group) to another parent node IAB-DU. The dual-connecting IAB-MT enables the SCG link using the Rel-15 NR-DC procedures.

For in-band operation, the IAB-node is typically subject to the half-duplex constraint, i.e., an IAB-node can only be in either transmission or reception mode at a time. Rel-16 IAB mainly considers the time-division multiplexing (TDM) case where the IAB-MT and IAB-DU resources of the same IAB-node are separated in time. Based on this consideration, the following resource types have been defined for IAB-MT and IAB-DU, respectively.

From an IAB-MT point-of-view, as in Rel-15, the following time-domain resources can be indicated for the parent link: downlink (DL) time resource; uplink (UL) time resource; and flexible (FL) time resource. From an IAB-node DU point-of-view, the child link has the following types of time resources: downlink time resource; uplink time resource; flexible time resource; and not-available (NA) time resources (resources not to be used for communication on the DU child links).

There are three ways to provide the DL/UL/FL configurations. One is semi-static configuration configured by TDD-UL-DL-ConfigurationCommon, or TDD-UL-DL-ConfiguDedicated. Another is radio resource control (RRC) configuration corresponding to a higher-layer configured DL symbols by, for example PDCCH, PDSCH, CSI-RS, etc. or UL symbols by, for example SRS, PUCCH, PUSCH, PRACH. A third is dynamically configured by downlink control information (DCI) formats.

Each of the downlink, uplink, and flexible time-resource types of the DU child link can belong to one of two categories: hard (H), where the corresponding time resource is always available for the DU child link; and soft (S), where the availability of the corresponding time resource for the DU child link is explicitly and/or implicitly controlled by the parent IAB-node.

The IAB-DU resources are configured per cell, and the H/S/NA attributes for the IAB-DU resource configuration are explicitly indicated per-resource type (D/U/F) in each slot. As a result, the semi-static time-domain resources of the IAB-DU part can be of seven types in total: Downlink-Hard (DL-H), Downlink-Soft (DL-S), Uplink-Hard (UL-H), Uplink-Soft (UL-S), Flexible-Hard (FL-H), Flexible-Soft (FL-S), and Not-Available (NA). The coordination relation between IAB-MT and IAB-DU resources are listed in Table 1.

TABLE 1
Coordination between IAB-MT and IAB-DU resources of an IAB-node.

| | | IAB-MT configuration | | |
|---|---|---|---|---|
| | | DL | UL | Flexible |
| DU | DL-H | DU: can transmit on | DU: can transmit on | DU: can transmit on |
| configuration | | DL unconditionally; | DL unconditionally; | DL unconditionally; |
| | | MT: not available. | MT: not available. | MT: not available. |
| | DL-S | DU: can transmit | DU: can transmit | DU: can transmit |
| | | conditionally; | conditionally; | conditionally; |
| | | MT: available on DL. | MT: available on UL. | MT: available on DL |
| | | | | & UL. |
| | UL-H | DU: can schedule UL | DU: can schedule UL | DU: can schedule UL |
| | | unconditionally; | unconditionally; | unconditionally; |
| | | MT: not available. | MT: not available. | MT: not available. |
| | UL-S | DU: can schedule UL | DU: can schedule UL | DU: can schedule UL |
| | | conditionally; | conditionally; | conditionally; |
| | | MT: available on DL. | MT: available on UL. | MT: available on DL |
| | | | | & UL. |
| | F-H | DU: can transmit on | DU: can transmit on | DU: can transmit on |
| | | DL or schedule UL | DL or schedule UL | DL or schedule UL |
| | | unconditionally; | unconditionally; | unconditionally; |
| | | MT: not available. | MT: not available. | MT: not available. |
| | F-S | DU: can transmit on | DU: can transmit on | DU: can transmit on |
| | | DL or schedule UL | DL or schedule UL | DL or schedule UL |
| | | conditionally; | conditionally; | conditionally; |
| | | MT: available on DL. | MT: available on UL. | MT: available on DL |
| | | | | & UL. |
| | NA | DU: not available; | DU: not available; | DU: not available; |
| | | MT: available on DL. | MT: available on UL. | MT: available on DL |
| | | | | & UL. |

Furthermore, a DU function may correspond to multiple cells, including cells operating on different carrier frequencies. Similarly, an MT function may correspond to multiple carrier frequencies. This can either be implemented by one MT unit operating on multiple carrier frequencies, or be implemented by multiple MT units, each operating on one carrier frequency. The H/S/NA attributes for the per-cell DU resource configuration should account for the associated MT carrier frequency(ies).

According to the definition, the explicitly configured Soft DU resource is by default unavailable if it is not indicated as available. There are two ways to indicate the availability from the parent IAB-node: implicit indication and explicit indication. For implicit indication, the IAB-node knows, via indirect means, such as lack of scheduling grant, no data available at MT, the IAB node being capable of simultaneous DU and MT, etc., that the DU resource can be used without impacting the MTs ability to transmit/receive. In addition to such implicit means, the IAB-node may also receive explicit indication from the parent IAB-node about the availability.

There currently exist certain challenges. For example, For example, Rel-16 IAB only supports inter-carrier inter-band multi-parent operation and only supports intra-donor multi-parent operation. Rel-17 IAB may consider inter-carrier intra-band multi-parent operation and inter-donor multi-parent operation.

For intra-donor multi-parent, the single IAB-donor-CU can coordinate the usage of overlapping resources between the two-parent links, as well as the usage of overlapping resources between each parent link and the child link(s). For example, the coordination may be: TDD pattern (Uplink/Downlink) alignment between the parent links; H/S/NA resource configuration of IAB-DU(s) and the parent IAB-DU(s); and/or explicit indication of IAB-DU soft resource.

For inter-donor multi-parent, the semi-static configuration is provided from two IAB-donors and a coordination between the two IAB-donors is needed.

For intra-band inter-carrier dual connectivity (DC), if the two carriers of the MCG and SCG links are too close for the IAB-MT to operate them independently, the IAB-MT is not able to support asynchronous TDD patterns, i.e., the multiple serving cells of MCG and SCG links cannot have different DL/UL transmission direction. In Rel-16 specification, the handling of transmission direction collision was only specified for the UE behaviour in half duplex CA operation. The existing methods are not designed for the multi-connectivity cases and do not account for the following aspects.

In the inter-donor multi-parent case, the semi-static resource configuration (e.g., UL/DL transmission direction) conflict may occur because the semi-static configurations are done by two IAB-donors that control the respective parent IAB-node. In the multi-parent case, the dynamic resource configuration (e.g., UL/DL transmission direction) conflict may occur because the dynamic configurations are provided by two independent MAC CE schedulers of the two parent IAB-nodes.

FIG. 6 includes two examples that illustrate that the dynamic indication from one parent IAB-node or both parent IAB-nodes can potentially cause UL/DL transmission conflict. This is mainly due to the lack of coordination between the two parent IAB-nodes, because each parent IAB-node is not aware of when the other parent IAB-node will provide a dynamic indication or the outcome of the dynamic indication (i.e., what transmission direction is indicated).

The conflict may also occur if one parent link receives semi-static re-configuration and the other parent link receives the dynamic indication.

To use the redundant routes concurrently, e.g., to achieve load balancing, reliability, etc., coordination to align DL/UL transmission direction is needed.

### SUMMARY

As described above, certain challenges currently exist with integrated access and backhaul (IAB) multi-parent uplink-downlink alignment. Certain aspects of the present disclosure and their embodiments may provide solutions to these or other challenges. For example, in particular embodiments when connecting to multiple parent IAB-nodes, information about the IAB-node's capability to use the multiple parent links with or without aligned transmission directions are provided to the network function unit, which is responsible for resource configuration of the involved IAB-nodes, and/or to each parent IAB-node. Based on the provided information, the network function unit can coordinate the resource at the associated parent IAB-nodes by assigning DU resource configuration accordingly. Each associated parent IAB-node may be provided with the resource configuration of the other parent IAB-node(s) that connect to the same IAB node. Some embodiments may use a prioritization order for the associated parent IAB-nodes when competing for a certain resource. Alternatively, a compatible resource configuration set may be defined and provided to the two parent IAB-nodes.

According to some embodiments, a method is performed by a network node operating as an IAB node operating in dual connectivity where an IAB-MT is connected to two IAB parents and two IAB donors. The method comprises: obtaining a semi-static flexible resource configuration from an IAB donor of the two IAB donors; obtaining a first uplink/downlink resource indication for a semi-statically configured flexible resource from a first IAB parent of the two IAB parents and a second uplink/downlink resource indication for a semi-statically configured flexible resource from a second IAB parent of the IAB parents; obtaining a priority associated with the first IAB parent and a priority associated with the second IAB parent; determining the first uplink/downlink resource indication conflicts with the second uplink/downlink indication; selecting one of the first uplink/downlink resource indication and the second uplink/downlink resource indication based on the priority associated with the first IAB parent and the priority associated with the second IAB parent; and communicating with the two IAB parents according to the selected uplink/downlink resource indication.

In particular embodiments, communicating with the two IAB parents according to the selected uplink/downlink resource indication comprises communicating with the IAB parent associated with a highest priority according to the selected uplink/downlink resource indication and disabling communication with the IAB parent not associated with the highest priority.

In particular embodiments, the method further comprises transmitting the selected uplink/downlink resource indication to the IAB parent not associated with the highest priority.

In particular embodiments, obtaining a first uplink/downlink resource indication from a first IAB parent of the two IAB parents and a second uplink/downlink resource configuration from a second IAB parent of the two IAB parents comprises receiving at least one of the first uplink/downlink resource indication and the second uplink/downlink resource indication via one of a semi-static indication and a dynamic indication.

In particular embodiments, the first IAB parent comprises a master cell group (MCG) parent and the second IAB parent comprises a secondary cell group (SCG) parent, and the priority associated with the first IAB parent is higher than the priority associated with the second IAB parent.

According to some embodiments, a method is performed by a network node operating as an IAB donor node operating in dual connectivity where an IAB node is connected to two IAB parent nodes and two IAB donors. The method comprises: receiving, from the IAB node, information on the transmission alignment capability of the IAB node with the two IAB parents; receiving, from the IAB node, information on the multiplexing capability of an IAB-MT and an IAB-DU of the IAB-node; determining, based on the transmission alignment capability of the IAB node with the two IAB parents and the information on the multiplexing capability of the IAB-MT and the IAB-DU of the IAB-node, a semi-static uplink/downlink/flexible resource configuration compatible with the IAB node and the two IAB parents; and transmitting the determined semi-static uplink/downlink/flexible resource configuration to the IAB node and the two IAB parents.

In particular embodiments, determining the uplink/downlink direction of the semi-static resource configuration is additionally based on one or more of interference condition, traffic demands, quality of service demands, latency/delay requirements, and link quality.

In particular embodiments, the IAB node is operating in dual connectivity with the two IAB parents.

In particular embodiments, the semi-static flexible resource configuration is compatible with the two IAB parents unless a first one of the two IAB parents indicates downlink at the same time a second one of the two IAB parents indicates uplink.

In particular embodiments, the semi-static flexible resource configuration comprises a first uplink/downlink resource indication associated with a first IAB parent of the two IAB parents and a second uplink/downlink resource indication associated with a second IAB parent of the two IAB parents, wherein the first uplink/downlink resource indication is compatible with the second uplink/downlink resource indication.

In particular embodiments, determining the semi-static uplink/downlink/flexible resource configuration comprises determining the semi-static flexible resource configuration comprises a first uplink/downlink resource indication associated with a first IAB parent of the two IAB parents that is not compatible with a second uplink/downlink flexible resource indication associated with a second IAB parent of the two IAB parents and selecting one of the first uplink/downlink resource indication and the second uplink/downlink resource indication based on a priority associated with the first uplink/downlink resource indication and a priority associated with the second uplink/downlink resource indication.

In particular embodiments, the first uplink/downlink resource indication is associated with a master cell group (MCG) and the second uplink/downlink resource indication is associated with a secondary cell group (SCG), and a priority associated with the first uplink/downlink resource indication is higher than a priority associated with the second uplink/downlink resource indication.

According to some embodiments, a network node comprises a wireless communication interface and processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, in particular embodiments, when an IAB-node connects to multiple parent IAB-nodes, resource coordination is used to align the DL/UL configuration among multiple parent links, for IAB-MTs that do not support simultaneous transmission and reception on any pair of the multiple serving cells configured for the multi-parent IAB-nodes in the same or different frequency bands.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a network diagram illustrating a multi-hop deployment in an integrated access and backhaul (IAB) network;

FIG. 2 is a network diagram illustrating IAB terminologies in adjacent hops;

FIG. 3 illustrates a reference diagram for a two-hop chain of IAB-nodes under an IAB-donor;

FIG. 4 illustrates examples for spanning tree (ST) and directed acyclic graph (DAG);

FIG. 5 illustrates IAB multi-parent scenarios;

FIG. 6 illustrates examples of potential configuration conflict by the dynamic indications, e.g., UL/DL transmission, from the parent IAB-nodes;

FIG. 7 illustrates a dual connected IAB-node;

FIG. 8 illustrates an example of conflict-less semi-static configurations;

FIG. 9 illustrates an example of a compatible configuration;

FIG. 10 is a block diagram illustrating an example wireless network;

FIG. 11 illustrates an example user equipment, according to certain embodiments;

FIGS. 12A and 12B are flowcharts illustrating example methods in a network node, according to certain embodiments;

FIG. 13 illustrates a schematic block diagram of a wireless device and network node in a wireless network, according to certain embodiments;

FIG. 14 illustrates an example virtualization environment, according to certain embodiments;

FIG. 15 illustrates an example telecommunication network connected via an intermediate network to a host computer, according to certain embodiments;

FIG. 16 illustrates an example host computer communicating via a base station with a user equipment over a partially wireless connection, according to certain embodiments;

FIG. 17 is a flowchart illustrating a method implemented, according to certain embodiments;

FIG. 18 is a flowchart illustrating a method implemented in a communication system, according to certain embodiments;

FIG. 19 is a flowchart illustrating a method implemented in a communication system, according to certain embodiments; and

FIG. 20 is a flowchart illustrating a method implemented in a communication system, according to certain embodiments.

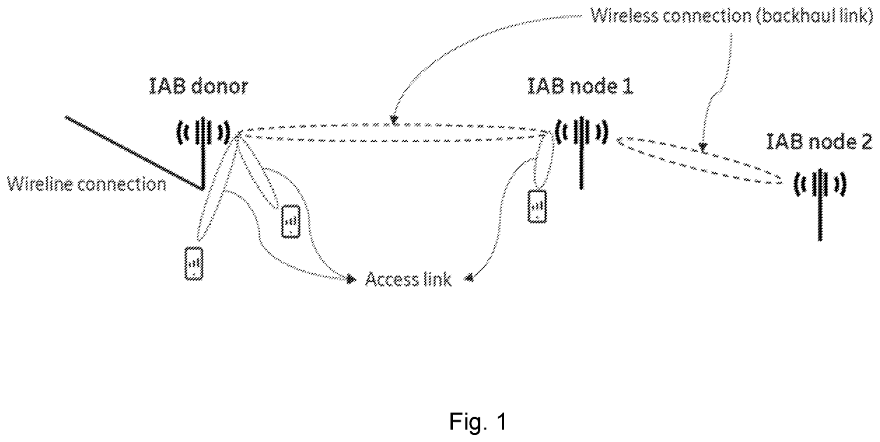

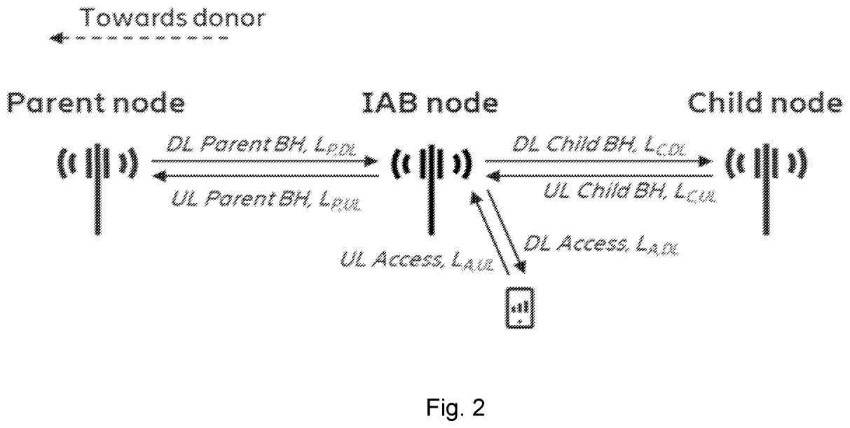

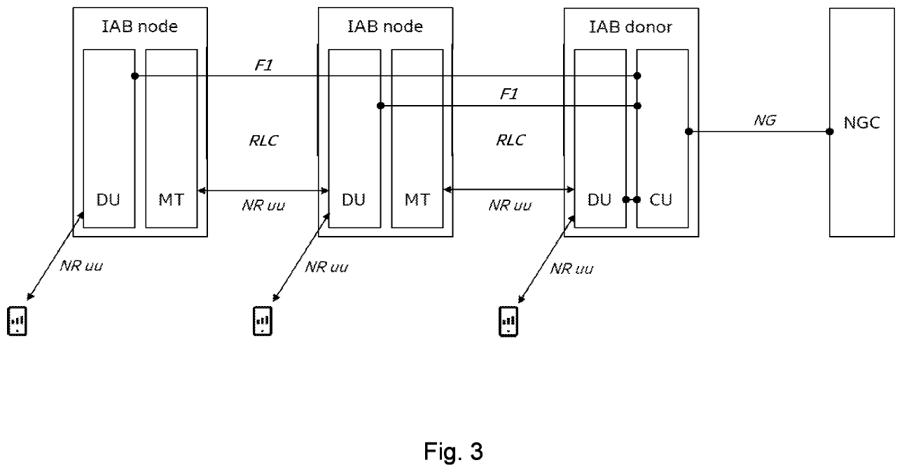

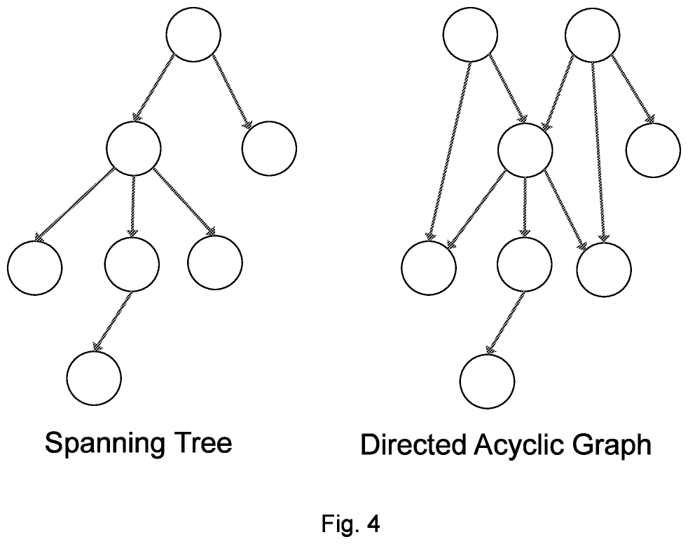

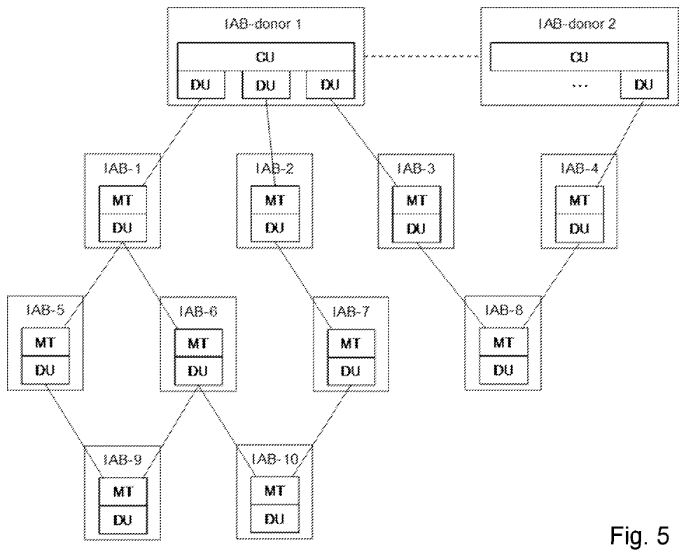

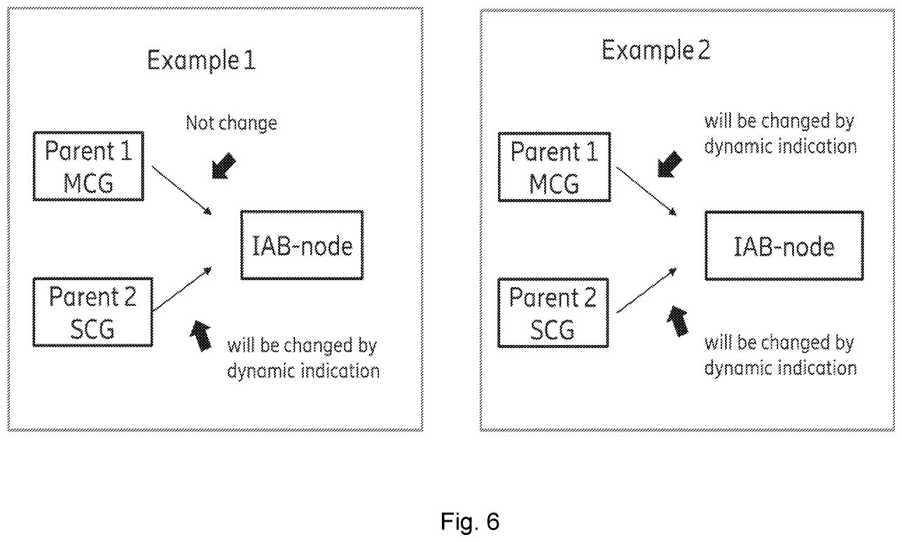

### DETAILED DESCRIPTION

As described above, certain challenges currently exist with integrated access and backhaul (IAB) multi-parent uplink-downlink alignment. Certain aspects of the present disclosure and their embodiments may provide solutions to these or other challenges. For example, in particular embodiments when connecting to multiple parent IAB-nodes, information about the IAB-node's capability to use the multiple parent links with or without aligned transmission directions are provided to the network function unit, which is responsible for resource configuration of the involved IAB-nodes, and/or to each parent IAB-node. Based on the provided information, the network function unit can coordinate the resource at the associated parent IAB-nodes by assigning DU resource configuration accordingly. Each associated parent IAB-node may be provided with the resource configuration of the other parent IAB-node(s) that connect to the same IAB node. Some embodiments may use a prioritization order for the associated parent IAB-nodes when competing for a certain resource. Alternatively, a compatible resource configuration set may be defined and provided to the two parent IAB-nodes.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

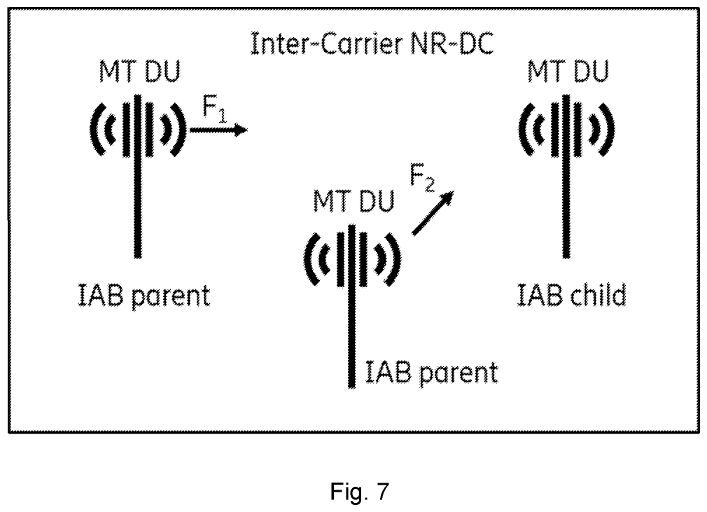

When operating in standalone mode, a NR+NR dual connected IAB-node can add redundant routes by establishing an MCG-link to one parent node IAB-DU and an SCG-link to another parent node IAB-DU. The dual-connecting IAB-MT will enable the SCG link using the Rel-15 NR-DC procedures. As described in TS 37.340, NR+NR dual connectivity is a multi-radio dual connectivity (MR-DC) configuration with the fifth generation core (5GC). In MR-DC, two or more component carriers (CCs) may be aggregated over two cell groups. An example is illustrated in FIG. 7.

Particular embodiments are described with respect to IAB-MT using NR-DC or EN-DC to connect to two parents and donors. The terms “network function” and “donor-CU” are used interchangeably.

As used herein, network-function is the center unit that provides resource configurations to IAB-DU and/or IAB-MT. The network function may be located at a node in the radio access network (RAN) (for example an IAB-CU), as a separate function residing in the core network (for example the Operation, Administration and Management (OAM) function), or as a virtual node in the cloud (including the above functions).

When an IAB-node connects to multiple parent IAB-nodes that are under control of different network functions, the reference network function (e.g., the reference donor-CU) is responsible for the IAB-DU configuration, because this is the CU that maintains the F1AP connection to the IAB-DU.

Particular embodiments include methods to handle the potential UL/DL directional conflict by semi-static and/or dynamic configuration. For simplicity, particular embodiments are described with respect to the dual-parent scenario, but the embodiments can be extended to the multi-parent scenario.

Particular embodiments include methods to handle configuration conflict due to semi-static UL/DL configuration. Some operations occur at the network function. The network function (e.g., an IAB-donor-CU) is responsible for resource configuration of their served IAB and parent nodes.

In the multi-connectivity mode, the network function receives information on the transmission alignment capability of the MCG carriers and SCG carriers from the IAB-node. In some embodiments, the capability is reported via the MCG link. in some embodiments, the capability can be reported via both MCG and SCG links.

The network function receives information on the multiplexing capability of IAB-MT and IAB-DU from the IAB-node and determines the semi-static UL/DL/FL resource configurations for the IAB-node and the parent IAB-nodes, based on information such as multiplexing capability, transmission alignment capability between different carriers, interference condition, traffic demands, quality of service demands, latency/delay requirement, and/or link quality.

The IAB-node does not expect a conflict of semi-static configured UL/DL directions between the MCG and SCG parent links. Thus, the network function further provides the semi-static UL/DL/FL resource configurations to the IAB-node and the parent IAB-nodes and provides the re-configuration of semi-static UL/DL/FL resources to the IAB-node, or the MCG parent IAB-node, or the SCG parent IAB-node.

The IAB-node does not expect a conflict of the UL/DL directions between the serving cells of the MCG and SCG parent links, due to the re-configuration of semi-static UL/DL resources.

Some operations occur at the MCG parent IAB-node. When an IAB-node has connected to the MCG parent IAB-node in the multi-connectivity mode, the MCG parent IAB node: receives its own resource configurations from the IAB-donor-CU; (optionally) receives the semi-static resource configuration of the IAB-node; (optionally) receives the semi-static resource configuration of the SCG parent IAB-nodes; and provides dynamic indication of the UL/DL direction to the dual-connected IAB-node

Some operations occur at the SCG parent IAB-node. When an IAB-node has connected to the SCG parent IAB-node in the multi-connectivity mode, the SCG parent IAB node: receives its own resource configurations from the IAB-donor-CU; (optionally) receives the semi-static resource configuration of the dual-connected IAB-node; (optionally) receives the semi-static resource configuration of the MCG parent IAB-node and the other SCG parent IAB-nodes; and provides dynamic indication of the UL/DL direction to the dual connected IAB-node

Some operations occur at the dual-connected IAB-node. When operating in the multi-connectivity mode, the dual-connected IAB-node receives semi-static resource configuration or re-configuration from the IAB-donor-CU and receives dynamic UL/DL indication from the MCG parent IAB-node, and/or the SCG parent IAB-node.

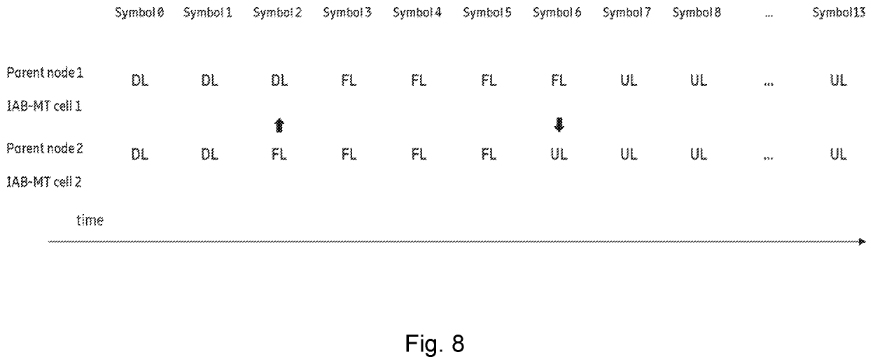

FIG. 8 illustrates an example of conflict-less semi-static configurations. For a given symbol, the two parent IAB-nodes can be configured with any combination other than DL/UL and UL/DL for cell 1 and cell 2. When the semi-static configurations are shared between the two parent IAB-nodes, it is also possible to avoid UL/DL collisions for those symbols by only one parent IAB-node being configured with FL resource. The parent IAB node can always indicate FL symbols with the same transmission direction as the semi-static configuration of the other parent IAB-node. For example, the Parent IAB-node 1 should indicate symbol 6 as UL, and the Parent IAB-node 2 should indicate symbol 2 as DL.

In some embodiments, the network controlled by the reference IAB-donor may have a different TDD pattern compared with the network controlled by the peer IAB-donor. Time-domain multiplexing of the two TDD patterns can be used to solve the UL/DL direction conflict. The reference and peer IAB-donors can enable the TDMed TDD patterns by using, for example, the H/S/NA configuration, e.g., by configuring a resource as Hard resource to enable the use of a resource and configuring a resource as Not-Available to disable the use of a resource.

In some embodiments, the methods described also apply to the UL/DL directional conflict caused by RRC-configuration, because the RRC-configuration is also under control of the donor-CU.

Some embodiments include methods to handle configuration conflict due to dynamic indication. Some embodiments include a prioritization order.

In some embodiments, a prioritization order is defined for the associated parent links to avoid a conflict configuration. A reference cell may be defined for the higher prioritized parent link. When a configuration conflict of UL/DL direction occurs, the other serving cells from the less prioritized parent links should apply the same configuration as the reference cell from the higher prioritized parent link, if a simultaneous operation of the dual parent links is possible. Otherwise, the operation of the less prioritized parent links may be disabled, i.e., the higher prioritized parent node gets to allocate resource prior to less prioritized parent nodes.

In some embodiments, the less prioritized parent IAB-node may be provided with dynamic indication of the configuration on UL/DL direction of the reference cell. The message may be transmitted via the commonly connected IAB node (this could be via a forward mechanism on MAC layer level or alternatively on BAP layer level). The message may be transmitted directly between the parent nodes if there can be a lower-layer channel between the parent IAB nodes. The higher prioritized parent link (reference cell) can forward the dynamic indication to the other serving cells. The message may be transmitted via a common grandparent node if the parent nodes have a common grandparent node. The common grandparent IAB-node can forward the dynamic indication of the higher prioritized parent link (reference cell) to the other serving cells.

In some embodiments, the higher prioritized parent node may be the MCG parent IAB-node. In some embodiments, the higher prioritized parent node may be one of the SCG parent IAB-node. In some embodiments, the prioritization may be configured semi-statically, based on one or more of the information above that is used for determining the semi-static UL/DL/FL resource configurations.

In some embodiments, a parent node or the dual-connected IAB node may realize that some symbols are more likely to result in a conflict than other symbols. For example, a symbol that is configured as F for both a first parent and second parent node, may dynamically be configured as conflicting if the two parent nodes dynamically configure the symbol differently. For this reason, the parent nodes or the IAB node may choose to down prioritize the use of F symbols.

In some embodiments, if there is a collision of UL/DL direction due to dynamic DCI indication, IAB-MT may prioritize reception over transmission.

In some embodiments, the prioritization rules may be determined by a specification.

Some embodiments include compatible configuration. In some embodiments, a compatible (conflict-less) configuration or set of compatible configurations is defined and provided to the two parent IAB-nodes in a DC scenario. It is assumed that each parent IAB-node will be provided with the semi-static UL/DL/FL configuration of the other parent IAB-node. Examples of how this can be done are the same as described in above. FL resources that are configured for both parent IAB nodes can only be applied if they are comprised in the compatible configuration set. For FL resources that are only configured for one parent IAB-node, the dynamic indication of UL/DL direction is not limited to the method of using compatible configuration sets.

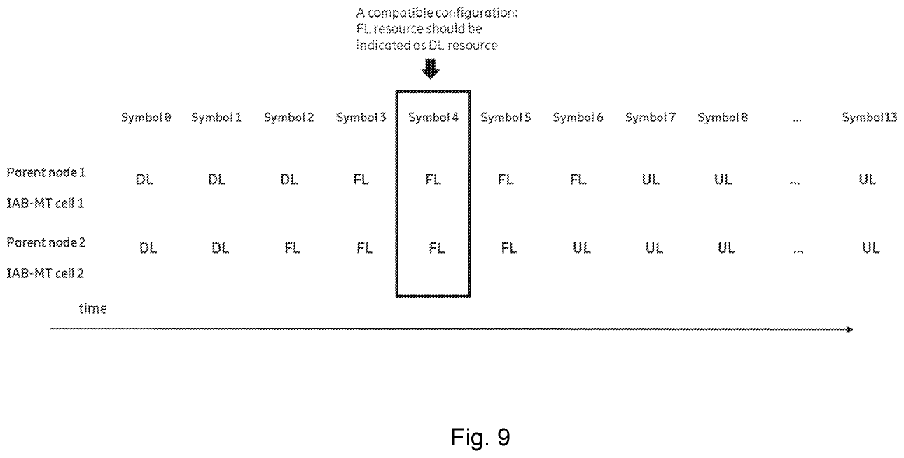

FIG. 9 illustrates an example of a compatible configuration where the FL resource should be configured as DL resource. Both Parent IAB-nodes have Symbol 4 as FL resource. By choosing the compatible configuration (FL->DL), the UL/DL alignment is ensured for Symbol 4.

In some embodiments, the compatible rules are provided to both parent IAB-nodes and the dual-connected IAB node by the IAB-donor-CU or the OAM.

In some embodiments, the compatible rule applies to an entire slot or set of slots. In some embodiments, the compatible rule applies to certain symbols of a slot.

In some embodiments, the compatible rule may contain different actions for the two parent IAB-nodes. In one example, one parent IAB-node can indicate FL resource as DL resource, while the other parent node can still indicate the FL resource as FL resource. In legacy operation, if a symbol is indicated as FL resource by both semi-static configuration and dynamic indication, the symbol will not be used for transmission and reception. In this case, the collision of UL/DL transmission is avoided.

In some embodiments, the dynamic indication includes all DCI-based signalling which can indicate UL/DL direction, for example: dynamic scheduling of PDSCH, CSI-RS by DCI format 1_0, DCI formation 1_1, DCI format 0_1; dynamic scheduling of PUSCH, PUCCH, PRACH, SR, by DCI formation 0_0, DCI format 0_1, DCI format 1_0, DCI formation 1_1, DCI format 2_3; and/or dynamic SFI of DCI format 2_0.

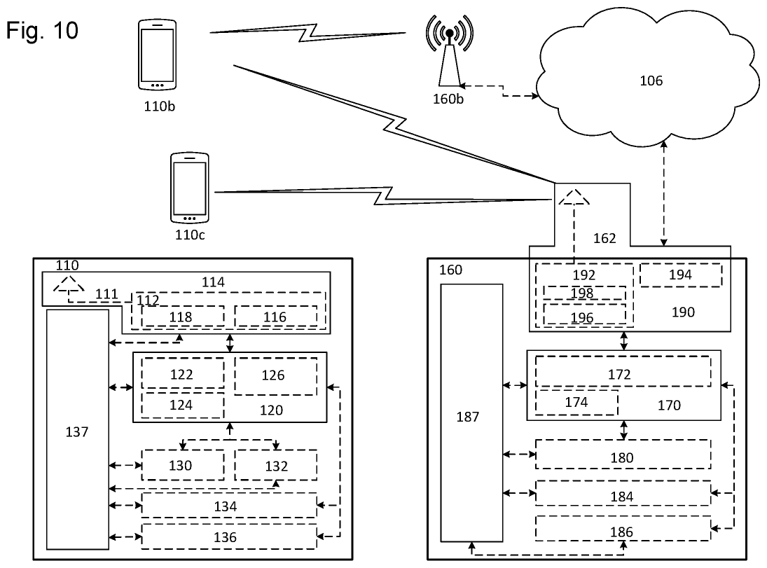

FIG. 10 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 160 includes processing circuitry 170, device readable medium 180, interface 190, auxiliary equipment 184, power source 186, power circuitry 187, and antenna 162. Although network node 160 illustrated in the example wireless network of FIG. 10 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 10 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IOT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IOT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

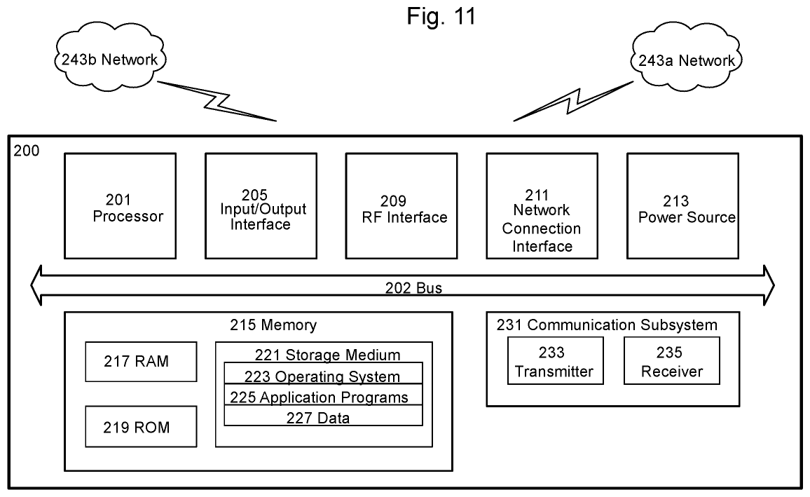

FIG. 11 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IOT UE, a machine type communication (MTC) UE, and/or an enhanced MTC (eMTC) UE. UE 200, as illustrated in FIG. 11, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may use all the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 11, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

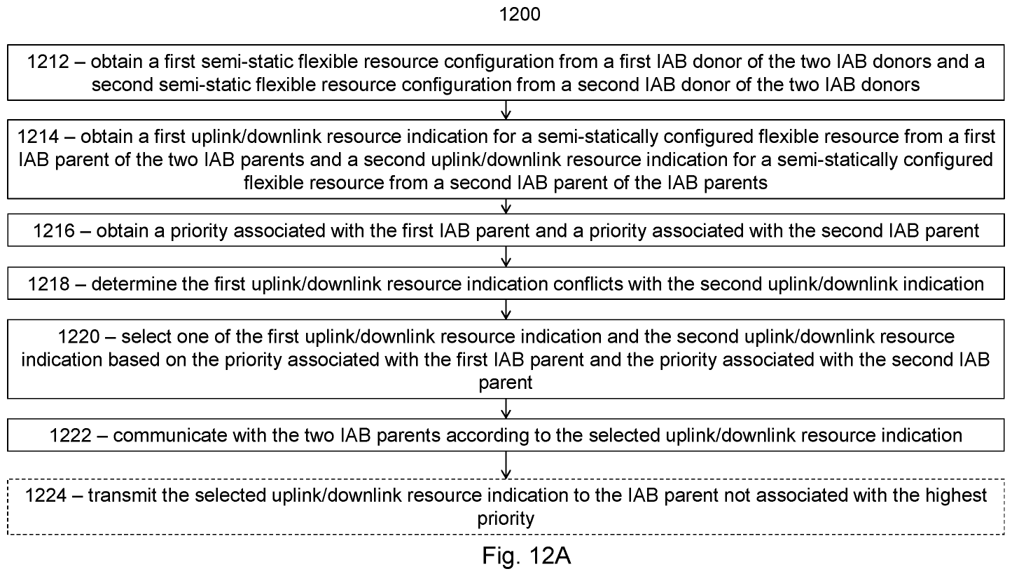

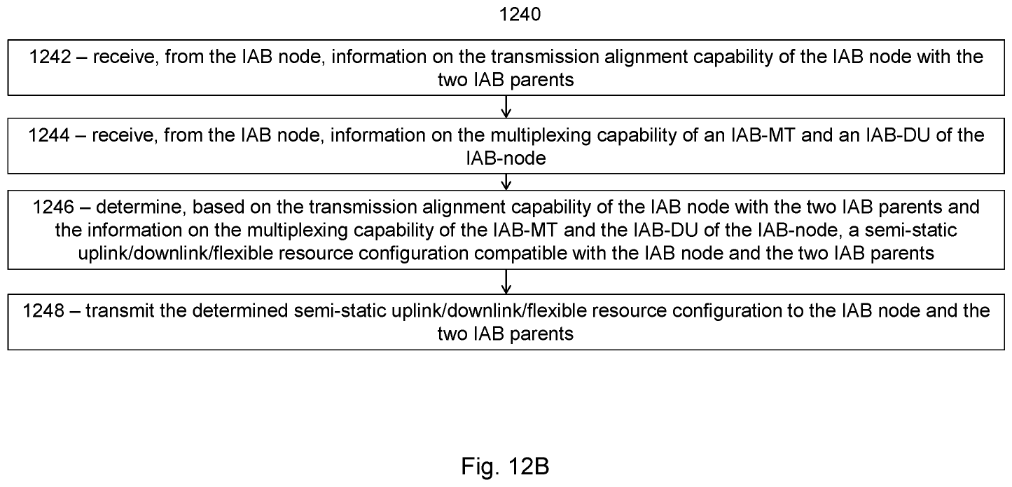

FIG. 12A is a flowchart illustrating an example method in a network node, according to certain embodiments. In particular embodiments, one or more steps of FIG. 12A may be performed by network node 160 described with respect to FIG. 10. The network node is operating as an IAB node using dual connectivity. An IAB-MT at the IAB node is connected to two IAB parents and two IAB donors.

The method may begin at step 1212, where the network node (e.g., network node 160) obtains a semi-static flexible resource configuration from an IAB donor of the two IAB donors. For example, the resource configuration may indicate whether particular IAB-MT resources are uplink, downlink, or flexible, as described in more detail above.

At step 1214, the network node obtains a first uplink/downlink resource indication for a semi-statically configured flexible resource from a first IAB parent of the two IAB parents and a second uplink/downlink resource indication for a semi-statically configured flexible resource from a second IAB parent of the IAB parents. For example, an IAB parent may configure an IAB-MT flexible resource as either uplink or downlink. The network node may receive a semi-static indication or a dynamic indication according to any of the embodiments and examples described above.

At step 1216, the network node obtains a priority associated with the first IAB parent and a priority associated with the second IAB parent. For example, the first IAB parent may comprise a master cell group (MCG) parent and the second IAB parent comprises a secondary cell group (SCG) parent, and the priority associated with the first IAB parent may be higher than the priority associated with the second IAB parent. In some embodiments, the priorities may be assigned according to any of the embodiments and examples described herein.

At step 1218, the network node determines the first uplink/downlink resource indication conflicts with the second uplink/downlink indication. For example, the two parent IAB nodes may not be in coordination with each other, and one parent IAB node may configure a flexible resource as uplink and the other parent node may configured the flexible resource as downlink, resulting in a conflict.

At step 1220, the network node selects one of the first uplink/downlink resource indication and the second uplink/downlink resource indication based on the priority associated with the first IAB parent and the priority associated with the second IAB parent. For example, to resolve the conflict determined in the previous step, the network node may select the uplink/downlink resource indication associated with the highest priority parent IAB node. In some embodiments, the network node may select the uplink/downlink resource indication according to any of the embodiments and examples described herein.

At step 1222, the network node communicates (e.g., uplink/downlink transmission) with the two IAB parents according to the selected uplink/downlink resource indication.

In particular embodiments, the network node may communicate with both IAB parents according to the selected uplink/downlink resource indication. In particular embodiments. communicating with the two IAB parents according to the selected uplink/downlink resource indication comprises communicating with the IAB parent associated with a highest priority according to the selected uplink/downlink resource indication and disabling communication with the IAB parent not associated with the highest priority.

In some embodiments, the network node may share the selected uplink/downlink resource indication with other network nodes. For example, at step 1224, the network node may transmit the selected uplink/downlink resource indication to the IAB parent not associated with the highest priority. For example, a first IAB parent may comprise an MCG parent and a second IAB parent may comprise an SCG parent. If the network node receives conflicting configuration from the first and second IAB parents and selects the configuration from the MCG parent, the network node may transmit that configuration to the SCG parent to inform the SCG parent of the configuration in use by the network node.

Modifications, additions, or omissions may be made to method 1200 of FIG. 12A. Additionally, one or more steps in the method of FIG. 12A may be performed in parallel or in any suitable order.

FIG. 12B is another flowchart illustrating an example method in a network node, according to certain embodiments. In particular embodiments, one or more steps of FIG. 12B may be performed by network node 160 described with respect to FIG. 10. The network node is operating as an IAB donor node. An IAB node is connected to two IAB parent nodes and two IAB donors via dual connectivity.

The method may begin at step 1242, where the network node (e.g., network node 160) receiving, from the IAB node, information on the transmission alignment capability (e.g., uplink/downlink/flexible resources) of the IAB node with the two IAB parents.

At step 1244, the network node receives, from the IAB node, information on the multiplexing capability of an IAB-MT and an IAB-DU of the IAB-node. The multiplexing capabilities are described in more detail above.

At step 1246, the network node determines, based on the transmission alignment capability of the IAB node with the two IAB parents and the information on the multiplexing capability of the IAB-MT and the IAB-DU of the IAB-node, a semi-static uplink/downlink/flexible resource configuration compatible with the IAB node and the two IAB parents.

In particular embodiments, determining the uplink/downlink direction of the semi-static resource configuration is additionally based on one or more of interference condition, traffic demands, quality of service demands, latency/delay requirements, and link quality.

The semi-static flexible resource configuration is compatible with the two IAB parents, for example, unless a first one of the two IAB parents indicates downlink at the same time a second one of the two IAB parents indicates uplink.

In some embodiments, a first uplink/downlink resource indication associated with a first IAB parent conflicts with a second uplink/downlink resource indication associated with a second IAB parent. In this case, the network node may select the uplink/downlink resource indication associated with a higher priority link or parent (e.g., select uplink/downlink resource indication associated with MCG parent over SCG parent).

At step 1248, the network node transmits the determined semi-static uplink/downlink/flexible resource configuration to the IAB node and the two IAB parents. In this way, both IAB parents and the IAB node have compatible configurations.

Modifications, additions, or omissions may be made to method 1240 of FIG. 12B. Additionally, one or more steps in the method of FIG. 12B may be performed in parallel or in any suitable order.

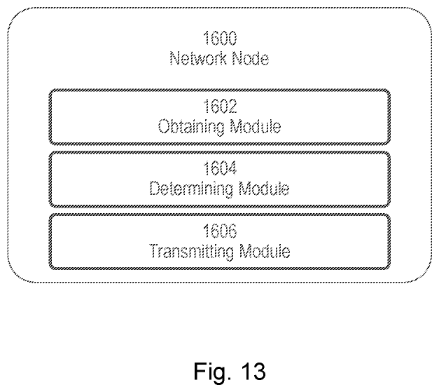

FIG. 13 illustrates a schematic block diagram of an apparatus in a wireless network (for example, the wireless network illustrated in FIG. 10). The apparatus includes a network node (e.g., network node 160 illustrated in FIG. 10). Apparatus 1600 is operable to carry out the example methods described with reference to FIGS. 12A and 12B, and possibly any other processes or methods disclosed herein. It is also to be understood that the methods of FIGS. 12A and 12B are not necessarily carried out solely by apparatus 1600. At least some operations of the method can be performed by one or more other entities.

Virtual apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause obtaining module 1602, determining module 1604, transmitting module 1606, and any other suitable units of apparatus 1600 to perform corresponding functions according one or more embodiments of the present disclosure.

As illustrated in FIG. 13, apparatus 1600 includes obtaining module 1602 configured to obtain/receive configuration information and to receive downlink signals, according to any of the embodiments and examples described herein. Apparatus 1600 also includes determining module 1604 configured to determine uplink/downlink/flexible resource configuration compatibility, according to any of the embodiments and examples described herein. Transmitting module 1606 is configured to transmit configuration data and uplink signals according to any of the embodiments and examples described herein.

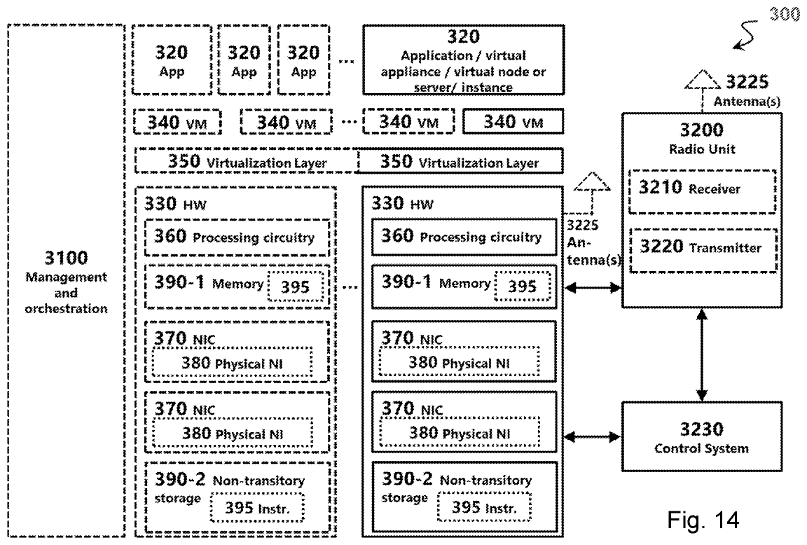

FIG. 14 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 14, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

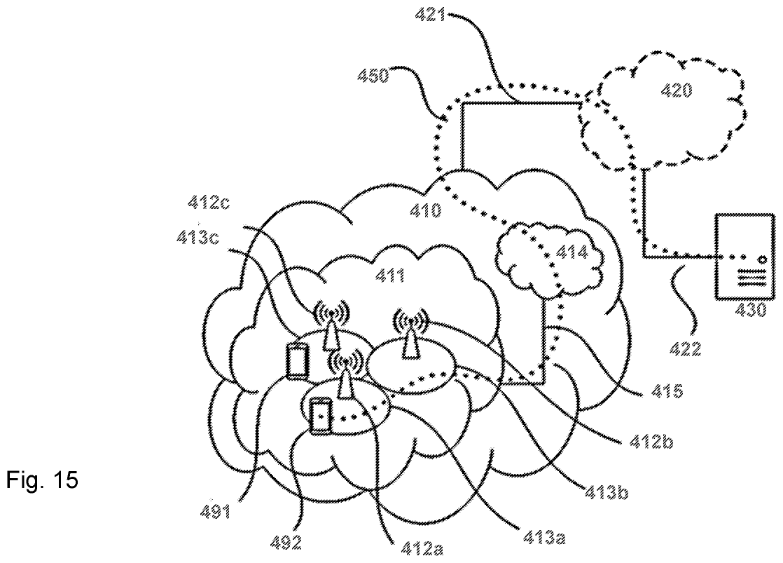

Still in the context of NFV, Virtual Network Function (VNF) is responsible for handling specific network functions that run in one or more virtual machines 340 on top of hardware networking infrastructure 330 and corresponds to application 320 in FIG. 15.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

With reference to FIG. 15, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 15 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

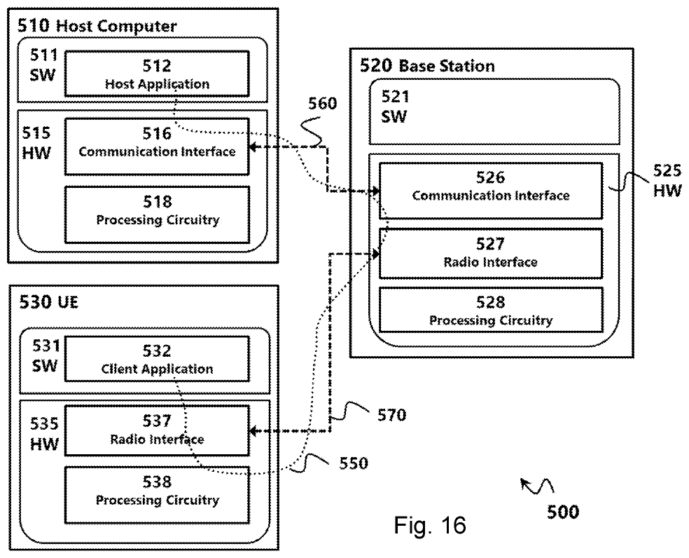

FIG. 16 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 16. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 16) served by base station 520. Communication interface 526 may be configured to facilitate connection 560 to host computer 510. Connection 560 may be direct, or it may pass through a core network (not shown in FIG. 16) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 16 may be similar or identical to host computer 430, one of base stations 412a, 412b, 412c and one of UEs 491, 492 of FIG. 15, respectively. This is to say, the inner workings of these entities may be as shown in FIG. 16 and independently, the surrounding network topology may be that of FIG. 15.

In FIG. 16, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, and thereby provide benefits such as reduced user waiting time, better responsiveness and extended battery life.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

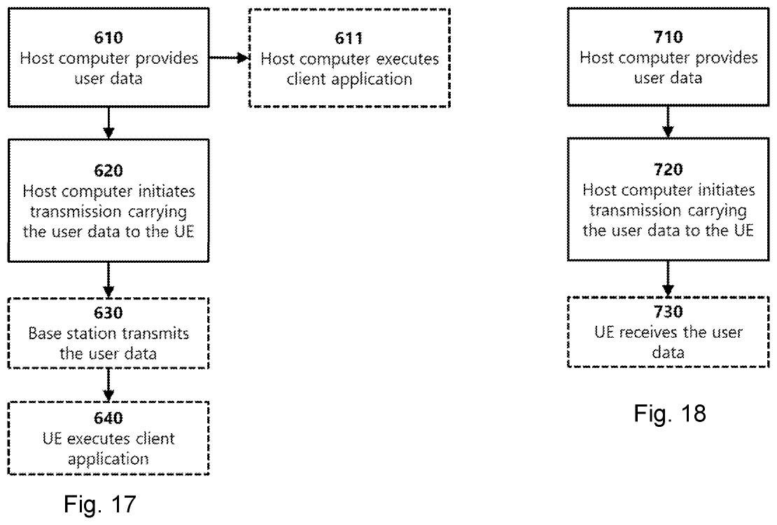

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

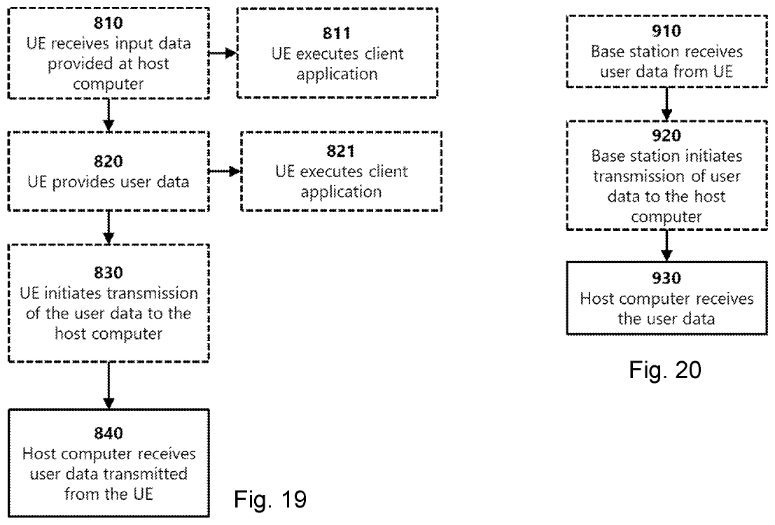

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1.-24. (canceled)

25. A method performed by a network node operating as an integrated access and backhaul (IAB) node operating in dual connectivity where an IAB-MT is connected to two IAB parents and two IAB donors, the method comprising:
obtaining a first semi-static flexible resource configuration from a first IAB donor of the two IAB donors and a second semi-static flexible resource configuration from a second IAB donor of the two IAB donors;
obtaining a first uplink/downlink resource indication for a semi-statically configured flexible resource from a first IAB parent of the two IAB parents and a second uplink/downlink resource indication for a semi-statically configured flexible resource from a second IAB parent of the IAB parents;
obtaining a priority associated with the first IAB parent and a priority associated with the second IAB parent;
determining the first uplink/downlink resource indication conflicts with the second uplink/downlink indication;
selecting one of the first uplink/downlink resource indication and the second uplink/downlink resource indication based on the priority associated with the first IAB parent and the priority associated with the second IAB parent; and
communicating with the two IAB parents according to the selected uplink/downlink resource indication.

26. The method of claim 25, wherein communicating with the two IAB parents according to the selected uplink/downlink resource indication comprises communicating with the IAB parent associated with a highest priority according to the selected uplink/downlink resource indication and disabling communication with the IAB parent not associated with the highest priority, optionally, the method further comprises transmitting the selected uplink/downlink resource indication to the IAB parent not associated with the highest priority.

27. The method of claim 25, wherein obtaining a first uplink/downlink resource indication from a first IAB parent of the two IAB parents and a second uplink/downlink resource configuration from a second IAB parent of the two IAB parents comprises receiving at least one of the first uplink/downlink resource indication and the second uplink/downlink resource indication via one of a semi-static indication and a dynamic indication.

28. The method of claim 25, wherein the first IAB parent comprises a master cell group (MCG) parent and the second IAB parent comprises a secondary cell group (SCG) parent, and the priority associated with the first IAB parent is higher than the priority associated with the second IAB parent.

29. A network node capable of operating as an integrated access and backhaul (IAB) node in dual connectivity where an IAB-MT is connected to two IAB parents and two IAB donors, the network node comprising processing circuitry operable to:
obtain a first semi-static flexible resource configuration from a first IAB donor of the two IAB donors and a second semi-static flexible resource configuration from a second IAB donor of the two IAB donors;
obtain a first uplink/downlink resource indication for a semi-statically configured flexible resource from a first IAB parent of the two IAB parents and a second uplink/downlink resource indication for a semi-statically configured flexible resource from a second parent of the IAB parents;
obtain a priority associated with the first IAB parent and a priority associated with the second IAB parent;
determine the first uplink/downlink resource indication conflicts with the second uplink/downlink indication;
select one of the first uplink/downlink resource indication and the second uplink/downlink resource indication based on the priority associated with the first IAB parent and the priority associated with the second IAB parent; and
communicate with the two IAB parents according to the selected uplink/downlink resource indication.

30. The network node of claim 29, wherein the processing circuitry is operable to communicate with the two IAB parents according to the selected uplink/downlink resource indication by communicating with the IAB parent associated with a highest priority according to the selected uplink/downlink resource indication and disabling communication with the IAB parent not associated with the highest priority, optionally the processing circuitry is further operable to transmit the selected uplink/downlink resource indication to the IAB parent not associated with the highest priority.

31. The network node of claim 29, wherein the processing circuitry is operable to obtain a first uplink/downlink resource indication from a first IAB parent of the two IAB parents and a second uplink/downlink resource configuration from a second IAB parent of the two IAB parents by receiving at least one of the first uplink/downlink resource indication and the second uplink/downlink resource indication via one of a semi-static indication and a dynamic indication.

32. The network node of claim 29, wherein the first IAB parent comprises a master cell group (MCG) parent and the second IAB parent comprises a secondary cell group (SCG) parent, and the priority associated with the first IAB parent is higher than the priority associated with the second IAB parent.

33. A method performed by a network node operating as an integrated access and backhaul (IAB) donor node operating in dual connectivity where an IAB node is connected to two IAB parent nodes and two IAB donors, the method comprising:
receiving, from the IAB node, information on the transmission alignment capability of the IAB node with the two IAB parents;
receiving, from the IAB node, information on the multiplexing capability of an IAB-MT and an IAB-DU of the IAB-node;
determining, based on the transmission alignment capability of the IAB node with the two IAB parents and the information on the multiplexing capability of the IAB-MT and the IAB-DU of the IAB-node, a semi-static uplink/downlink/flexible resource configuration compatible with the IAB node and the two IAB parents; and
transmitting the determined semi-static uplink/downlink/flexible resource configuration to the IAB node and the two IAB parents.

34. The method of claim 33, wherein determining the uplink/downlink direction of the semi-static resource configuration is additionally based on one or more of interference condition, traffic demands, quality of service demands, latency/delay requirements, and link quality.

35. The method of claim 33, wherein the IAB node is operating in dual connectivity with the two IAB parents.

36. The method of claim 33, wherein the semi-static flexible resource configuration is compatible with the two IAB parents unless a first one of the two IAB parents indicates downlink at the same time a second one of the two IAB parents indicates uplink.

37. The method of claim 33, wherein the semi-static flexible resource configuration comprises a first uplink/downlink resource indication associated with a first IAB parent of the two IAB parents and a second uplink/downlink resource indication associated with a second IAB parent of the two IAB parents, wherein the first uplink/downlink resource indication is compatible with the second uplink/downlink resource indication.

38. The method of claim 33, wherein determining the semi-static uplink/downlink/flexible resource configuration comprises determining the semi-static flexible resource configuration comprises a first uplink/downlink resource indication associated with a first IAB parent of the two IAB parents that is not compatible with a second uplink/downlink flexible resource indication associated with a second IAB parent of the two IAB parents and selecting one of the first uplink/downlink resource indication and the second uplink/downlink resource indication based on a priority associated with the first uplink/downlink resource indication and a priority associated with the second uplink/downlink resource indication, optionally,
wherein the first uplink/downlink resource indication is associated with a master cell group (MCG) and the second uplink/downlink resource indication is associated with a secondary cell group (SCG), and a priority associated with the first uplink/downlink resource indication is higher than a priority associated with the second uplink/downlink resource indication.

39. A network node capable of operating as an integrated access and backhaul (IAB) donor node operating in dual connectivity where an IAB node is connected to two IAB parents and two IAB donors, the network node comprising processing circuitry (170) operable to:
receive, from the IAB node, information on the transmission alignment capability of the IAB node with the two IAB parents;
receive, from the IAB node, information on the multiplexing capability of an IAB-MT and an IAB-DU of the IAB-node;
determine, based on the transmission alignment capability of the IAB node with the two IAB parents and the information on the multiplexing capability of the IAB-MT and the IAB-DU of the IAB-node, a semi-static uplink/downlink/flexible resource configuration compatible with the IAB node and the two IAB parents; and
transmit the determined semi-static uplink/downlink/flexible resource configuration to the IAB node and the two IAB parents.

40. The network node of claim 39, wherein the processing circuitry is further operable to determine the uplink/downlink direction of the semi-static resource configuration based on one or more of interference condition, traffic demands, quality of service demands, latency/delay requirements, and link quality.

41. The network node of claim 39, wherein the IAB node is operating in dual connectivity with the two IAB parents.

42. The network node of claim 39, wherein the semi-static flexible resource configuration is compatible with the two IAB parents unless a first one of the two IAB parents indicates downlink at the same time a second one of the two IAB parents indicates uplink.

43. The network node of claim 39, wherein the semi-static flexible resource configuration comprises a first uplink/downlink resource indication associated with a first IAB parent of the two IAB parents and a second uplink/downlink resource indication associated with a second IAB parent of the two IAB parents, wherein the first uplink/downlink resource indication is compatible with the second uplink/downlink resource indication.

44. The network node of claim 39, wherein the processing circuitry is operable to determine the semi-static uplink/downlink/flexible resource configuration by determining the semi-static flexible resource configuration comprises a first uplink/downlink resource indication associated with a first IAB parent of the two IAB parents that is not compatible with a second uplink/downlink flexible resource indication associated with a second IAB parent of the two IAB parents and selecting one of the first uplink/downlink resource indication and the second uplink/downlink resource indication based on a priority associated with the first uplink/downlink resource indication and a priority associated with the second uplink/downlink resource indication, optionally,
wherein the first uplink/downlink resource indication is associated with a master cell group (MCG) and the second uplink/downlink resource indication is associated with a secondary cell group (SCG), and a priority associated with the first uplink/downlink resource indication is higher than a priority associated with the second uplink/downlink resource indication.
